(19) United States
(12) Patent Application Publication
(10) Pub. No.: US 2009/0161034 A1
(43) Pub. Date: Jun. 25, 2009

(54) Drive schemes for driving cholesteric liquid crystal material into the focal conic state

(76) Inventors: David Coates, Dorset (GB); Amir Ben Shalom, Modiin (IL); Shlomit Angel-Devir, Jerusalem (IL); Christopher John Hughes, Reading (GB)

Correspondence Address: Pearl Cohen Zedek Latzer, LLP, 1500 Broadway, 12th Floor, New York, NY, 10036, US

(21) Appl. No.: 11/629,095

(22) PCT Filed: Jun. 14, 2005
(86) PCT No.: PCT/GB05/02348

§ 371 Date: Sep. 22, 2008

(30) Foreign Application Priority Data
Jun. 14, 2004 (IL) 162491

(51) Int. Cl. G02F 1/137

(52) U.S. Cl. 349/35

(57) ABSTRACT

In a cholesteric liquid crystal display device (24), to drive a surface-stabilized layer of cholesteric liquid crystal material into the focal conic state, there is applied drive signal comprising a series of pulses (30, 34, 35, 36, 37, 38, 41). At least one initial pulse has sufficient energy to drive the layer of cholesteric liquid crystal material into the homeotropic state and the subsequent pulses have time-averaged energies which reduce to a minimum level at which the layer of cholesteric liquid crystal material is driven into the focal conic state. This produces a focal conic state of particularly low reflectance, which allows a high contrast ratio to be achieved.

The present invention relates to the driving of cholesteric liquid crystal material into the focal conic state. It has particular application in a cholesteric liquid crystal display device in which the focal conic state is used as the dark state.

The following refers to a number of technical papers for which full references are given in a list of references at the end of this description.

Cholesteric liquid crystal display devices, often known as stabilized cholesteric texture (SCT) display devices are well known. These display devices make use of cholesteric liquid crystal material which is a type of material having two stable states, that is a coloured reflecting state arising from the planar texture (planar state) of the cholesteric liquid crystal material and a slightly light backscattering state arising from the focal conic texture (focal conic state), this state being almost transparent relative to the reflecting state. In commercially available SCT display devices, the focal conic state acts as the dark state, the display devices having a black background layer to absorb the transmitted light.

These stable states are accessed via a metastable homeotropic state that is transparent and only present when an electric field above a critical field (Vc) is applied to the liquid crystal that must be of positive dielectric anisotropy. These effects were described initially by Greubel and then by others for example in U.S. Pat. No. 5,463,863.

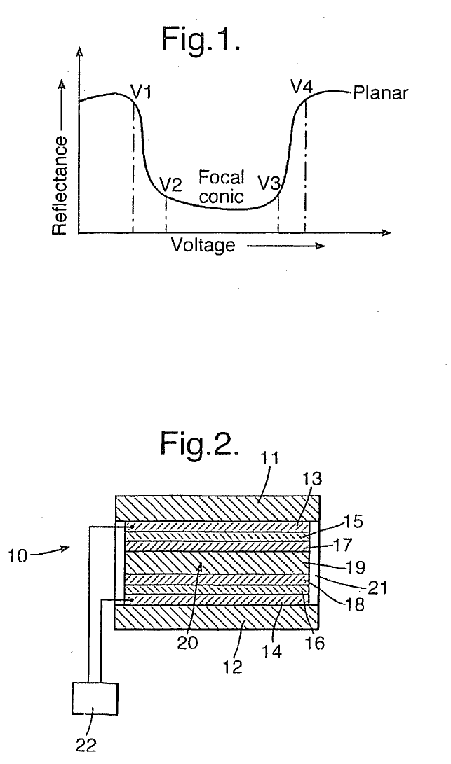

The behaviour of the cholesteric liquid crystal material can be understood as follows. The cholesteric liquid crystal material can be driven into the planar state by applying a high voltage above Vc to drive the material into the homeotropic state then removing the drive signal so that the material relaxes into the planar state. Subsequently, a drive pulse of a given voltage may be applied and thereafter the reflectance of the material against a black background can be measured. This process of driving the material into the planar state and then applying a drive pulse can be repeated for drive pulses of different voltages to produce a curve of reflectance against voltage having a shape as shown in FIG. 1. This curve has critical points V1 to V4 marking the transitions between the various stable states of the material. Note that V4 is the same as the critical voltage Vc referred to above. For drive pulses below V1 and above V4 the material is in the planar state and for drive pulses between V2 and V3 the material is in the focal conic state. The curve also shows that there are stable states of variable reflectance between V1 and V2 and between V3 and V4, which states can be used to produce grey levels in a display device.

The curve of FIG. 1 forms the basis for most drive schemes for cholesteric liquid crystal displays. For example, a basic drive scheme is to use drive pulses of the type used to produce the curve of FIG. 1, that is an initial pulse to drive the material into the homeotropic state, followed by a relaxation period, followed by a selection pulse of variable energy to select a stable state of variable reflectance.

As the values of V1 to V4 vary depending on the precise nature and configuration of the display device, for most drive schemes the values of V1 to V4 must be determined for the display device in question. This is burdensome in the manufacture of SCT display devices as it calls either for manufacture of devices to tight specifications so that V1 to V4 are predictable or for individual testing and set-up of manufactures devices.

The contrast ratio of an SCT display device is defined as the ratio of the reflectance of the bright state to the reflectance of the dark state. To achieve a high contrast the cholesteric liquid crystal material should have a high reflectance in the bright state, but it is equally critical that the cholesteric liquid crystal material should have a low reflectance in the dark state (that occurs in commercially available SCT display devices when the liquid crystal material is in the focal conic state) and not degraded by the backscattering of light. Thus, to produce high contrast ratio SCT display devices there is a need to provide a dark state of low reflectance.

Additionally, when a stack of three different cells having layers of cholesteric liquid crystal which reflect light of different colours (usually red, green and blue), are used to produce a full colour display device, the colours produced by the lower cells are modified by the light scattering in the upper cells. Very often, the alignment of the layers of liquid crystal material is optimized to try and achieve a low light scattering focal conic state while still giving a bright planar state. The alignment must also allow the states to be stable without any voltage applied. It is not always feasible to find all these optimizations within an alignment layer.

The first articles by Gerber on long pitch length cholesteric devices (which reflect IR light) teach that if the electrical field (initially above a critical voltage Vc) is switched off quickly a planar texture is formed. Gerber also teaches that if the field is switched off slowly a finger print texture is formed, this could be considered to be related to the focal conic texture exhibited in shorter pitch cholesteric liquid crystal mixtures.

Besides the basic drive scheme described above, two further drive schemes which have been discussed in the literature will now be reviewed.

The first further drive scheme is that described by Doane applies a high voltage pulse to drive the material into the homeotropic state, then a fast switch off to zero volts to give planar texture or a fast switch off to a lower voltage to give a focal conic texture. The latter of these can have a pause between the high voltage and low voltage pulses. Additionally, the low voltage pulses can be repeated several times to reduce the light scattering of the focal conic texture. This is a slow addressing scheme.

The second further drive scheme is referred to as a dynamic drive scheme and was suggested by Huang et al., by Zhu and Huang and by Huang and Stefanov. This scheme consists of five elements, preparation, post preparation, selection, post selection and evolution. This makes use of the fact that it is possible to switch the liquid crystal director from some positions very readily, this first movement being accomplished during the preparation times. However while it is much faster than the previous scheme it does not attempt to create a less scattering focal conic drive scheme.

Accordingly, one can fairly state that there are two longstanding needs in the art. The first need relates to improved contrast in a cholesteric liquid crystal display device. The second need relates to relaxation of LCD fabrication specifications, which simply stated corresponds to a manufacturer's cost reduction. It would be desirable to meet either one of these needs.

According to a first aspect of the present invention, there is provided a method of driving a layer of cholesteric liquid crystal material into the focal conic state, the method comprising applying a drive signal to the layer of cholesteric liquid crystal material, the drive signal comprising a series of pulses wherein at least one initial pulse has sufficient energy to drive the layer of cholesteric liquid crystal material into the homeotropic state and the subsequent pulses have time-averaged energies which reduce to a minimum level at which the layer of cholesteric liquid crystal material is driven into the focal conic state.

Similarly, according to a second aspect of the present invention there is provided a cholesteric liquid crystal display device comprising:

at least one cell comprising a layer of cholesteric liquid crystal material and an electrode arrangement capable of applying a drive signal to the layer of cholesteric liquid crystal material; and

a drive circuit arranged to supply a drive signal to the electrode arrangement for application to the layer of cholesteric liquid crystal material to drive the liquid crystal material into the focal conic state, the drive signal comprising a series of pulses wherein at least one initial pulse has sufficient energy to drive the layer of cholesteric liquid crystal material into the homeotropic state and the subsequent pulses have time-averaged energies which reduce to a minimum level at which the layer of cholesteric liquid crystal material is driven into the focal conic state.

Thus the present invention enables driving into the focal conic state using a drive signal comprising a series of pulses. One or more initial pulses drive the cholesteric liquid crystal material into the homeotropic state. Subsequent pulses are of reducing time-averaged energies. Such a series of pulses has been found to drive the liquid crystal material into the focal conic state. Of even greater significance, it has been found that the focal conic state produced by such a series of drive pulses is of low reflectance, in particular of lower reflectance than that produced by the known drive schemes described above. Thus the present invention allows a higher contrast ratio to be achieved by the display device. Similarly, in the case of a display device having a stack of layers of cholesteric liquid crystal material, the reduced backscattering in the focal conic state improves the overall colour gamut of the display device.

Another advantage is that the drive scheme allows the focal conic state to be reliably achieved with a much lesser dependence on the precise nature and configuration of the display device than the known drive schemes described above. In particular there is no need for detailed knowledge of the V1 to V4 voltages of FIG. 1. Whilst it is necessary is that the at least one initial pulse has sufficient energy to drive the layer of cholesteric liquid crystal material into the homeotropic state, this is easily achieved for a wide range of displays simply by providing the pulse with a relatively high energy, for example by choosing a high voltage for the pulse. Similarly, it is necessary for the minimum level to which the time-averaged energy of the subsequent pulses is reduced must be sufficiently low to drive the cholesteric liquid crystal material into the focal conic state, but again this is easily achieved. To minimise the design constraint, the time-averaged energy may reduce to a minimum value of zero. More rapid driving to the focal conic state may be achieved by selecting a higher minimum level, it being straightforward to select the actual value of the minimum level by testing display devices with varied series of pulses.

This reduced dependence on the precise nature and configuration of the display device produces a significant advantage in manufacture by relieving the manufacturing tolerances and/or testing of individual display device. For example the thickness of the layer of liquid crystal material is less critical. This is very important as it reduces cost of manufacture and increases yield.

A related advantage is that the drive scheme may be used on flexible display devices which would otherwise create problems in driving due to the thickness locally varying in an unpredictable manner when the display device is flexed.

The physical phenomenum experienced by the molecules of the cholesteric liquid crystal material is not entirely understood but the following comments may be useful nonetheless. It is believed likely that the final state is a focal conic state and that the reason for the reduced scattering is that the size of the domains resulting from the applied signal is either made on average either larger or smaller compared to the wavelength of visible light so that the amount of scattering of visible light is reduced. The physical mechanism by which this is achieved by the series of pulses is not clear. However, this uncertainty about the physical phenomenum does not affect the implementation of the invention which is based on the actual observation that the series of drive pulses as described above can be used to drive the cholesteric liquid crystal material into the focal conic state of low reflectance.

It is to be noted that the present invention can be applied in addition to any surface treatments and is applicable to any cholesteric liquid crystal material and any alignment type.

According to a further aspect of the present invention, there is provided a surface-stabilized cholesteric texture liquid crystal display device including (A) at least one environmentally encapsulated layer of voltage addressable Cholesteric material and having a predetermined optical surface coating (such as a black absorbing layer) furthest from a viewer; and (B) electronic driving means for applying predetermined voltage sequences to substantially each respective addressable location in the Cholesteric material, and the driving means is characterized by direct switching of respective voltage-to-Cholesteric-material elements from a homeotropic field on state into a low light scattering focal conic texture state using a time domain proximate plurality of substantially collectively neutral electrical pulses and within the plurality (i) there is a pulse above V4 voltage-energy-state to reset the element and (ii) thereafter there is a clustered subset of pulses digressing in respective voltage-energy-states at least until a substantially V2 or a substantially V3 voltage-energy-state is included therein; and (iii) direct switching of the element from a low light scattering focal conic texture state into a homeotropic field on state using any known driving scheme.

According to a yet further aspect of the present invention, there is provided a method for driving optical state-to-state transitions in a substantially encapsulated cholesteric element via electrical addressing thereto and the method includes the steps of (1) direct switching of the element from a homeotropic field on state into a low light scattering focal conic texture state using a time domain proximate plurality of substantially collectively neutral electrical pulses and within the plurality (1a) there is a pulse above V4 voltage-energy-state to reset the element and (1b) thereafter there is a clustered subset of pulses digressing in respective voltage-energy-states at least until a substantially V2 or a substantially V3 voltage-energy-state is included therein; and (2) direct switching of the element from a low light scattering focal conic texture state into a homeotropic field on state using any known driving scheme.

According to a yet further aspect of the present invention, there is provided a drive method to achieve cell transparency for a cholesteric material substantially encapsulated therein wherein there is a driving “voltage×duration” envelop having a plurality of regions—including an above “V4 voltage×duration” region and going down to a below “V2-or-V3 voltage×duration” region. (By “voltage×duration” we mean the area of the pulse (which for square pulses is height=voltage multiplied by width=duration however other shaped pulses will require integration or approximation to calculate) or the total energy of the pulse (which may be calculated in an equivalent manner to the area).

According to a yet further aspect of the present invention, there is provided a method for driving a cholesteric material, in at least one substantially encapsulated cell, from a homeotropic field-on state into a low light scattering focal conic texture state, by applying a predetermined sequenced plurality of energy pulses including (1) Applying to a cell, of the at least one cells, at least one initial pulse in the plurality having an above “V4 voltage×duration” energy; and (2) Applying to the cell at least one final pulse in the plurality of having a below “V2-or-V3 voltage×duration” energy; and (3) wherein any applying to the cell of any pulse in the plurality, between the at least one initial pulse and the at least one final pulse, has an energy between “V4 voltage×duration” and “V2-or-V3 voltage×duration”.

To allow better understanding, an embodiment of the present invention will now be described by way of non-limitative example with reference to the accompanying drawings, in which:

FIG. 1 is graph of reflectance against voltage for drive pulses applied to a cholesteric liquid crystal material initially in the planar state;

FIG. 2 is a cross-sectional view of a cell of a cholesteric liquid crystal display device;

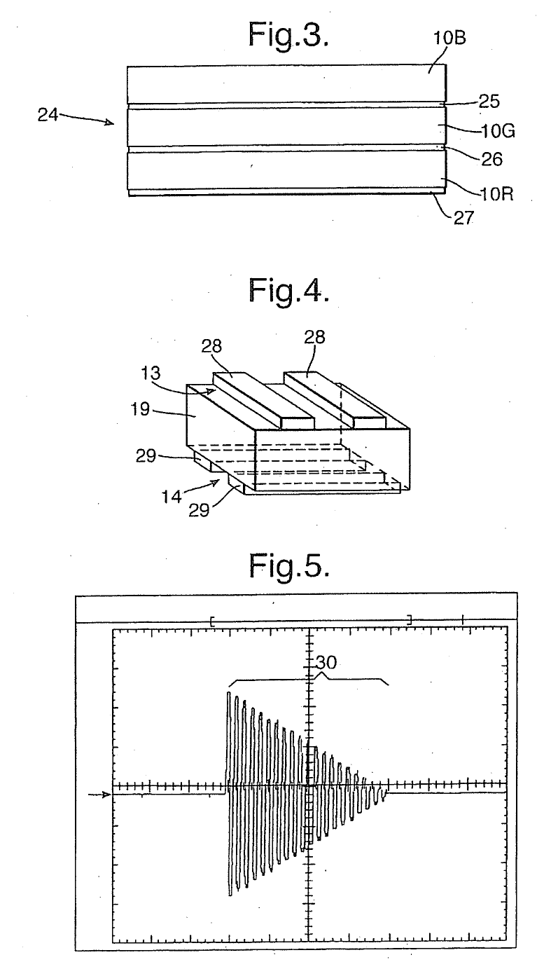

FIG. 3 is a cross-sectional view of a cholesteric liquid crystal display device;

FIG. 4 is a perspective view of the electrode arrangement of the cell of FIG. 2;

FIG. 5 is an oscilloscope trace of a drive signal applied to the cholesteric liquid crystal material of a cell;

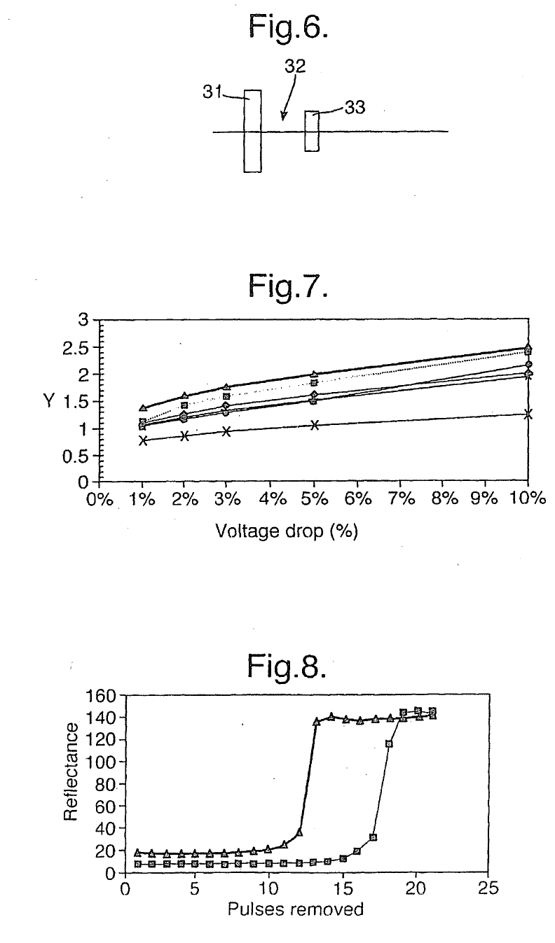

FIG. 6 is a view of a known drive signal;

FIG. 7 is a graph of the degree of back scattered light against the voltage drop of successive pulse in the drive signal of FIG. 5;

FIG. 8 is a graph of the reflectance of a cell to which the drive signal of FIG. 5 is applied with dropped pulses against the number of pulses dropped; and

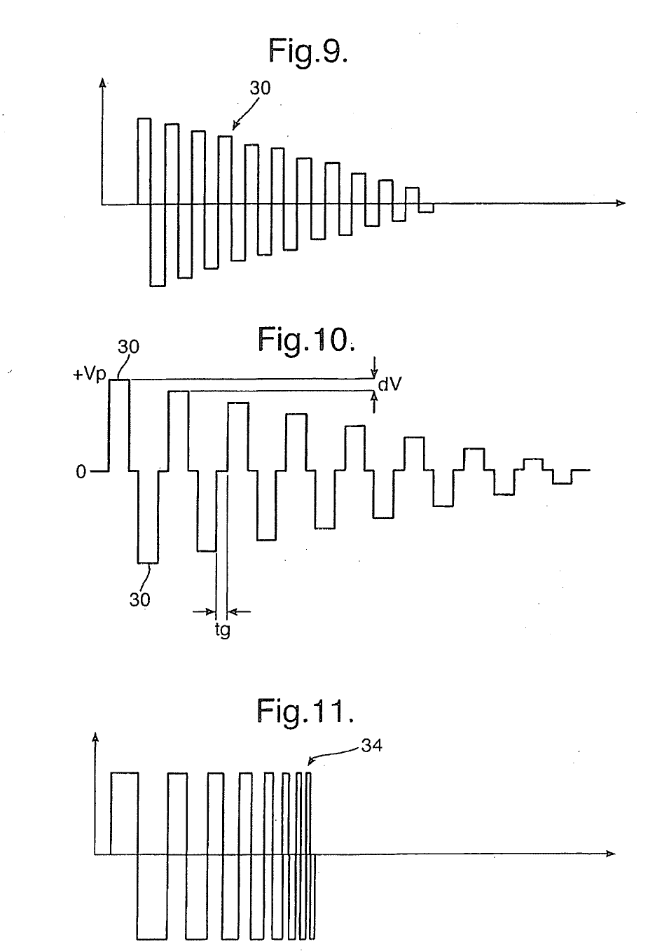

FIGS. 9 to 16 are graphs of voltage over time for some alternative drive signals.

There will first be described a cholesteric liquid crystal display device 24 to which the drive scheme may be applied. A cell 10 of the display device 24 is shown in FIG. 2 and has a layered construction, the thickness of the individual layers 11 to 19 being exaggerated in FIG. 2 exaggerated for clarity.

The cell 10 comprises two rigid substrates 11 and 12, which may be made of glass or preferably plastic. The substrates 11 and 12 have, on their inner facing surfaces, respective transparent conductive layers 13 and 14 formed as a layer of transparent conductive material, typically indium tin oxide. The conductive layers 13 and 14 are patterned to provide a rectangular array of directly addressable pixels, as described in more detail below.

Optionally, each conductive layers 13 and 14 is overcoated with a respective insulation layer 15 and 16, for example of silicon dioxide, or possibly plural insulation layers.

The substrates 11 and 12 define between them a cavity 20, typically having a thickness of 3 μm to 8 μm. The cavity 20 contains a liquid crystal layer 19 and is sealed by a glue seal 21 provided around the perimeter of the cavity 20. Thus the liquid crystal layer 19 is arranged between the conductive layers 13 and 14.

Each substrate 11 and 12 is further provided with a respective alignment layer 17 and 18 formed adjacent the liquid crystal layer 19, covering the respective conductive layer 13 and 14, or the insulation layer 15 and 16 if provided. The alignment layers 17 and 18 align and stabilise the liquid crystal layer 19 and are typically made of polyamide which may optionally be unidirectionally rubbed. Thus, the liquid crystal layer 19 is surface-stabilised, although it could alternatively be bulk-stabilised.

The liquid crystal layer 19 comprises cholesteric liquid crystal material. Such material has several states in which the reflectivity and transmissivity vary. These states are the planar state, the focal conic state and the homeotropic (pseudo nematic) state, as described in I. Sage, “Liquid Crystals Applications and Uses”, Editor B Bahadur, vol 3, page 301, 1992, World Scientific, which is incorporated herein by reference and the teachings of which may be applied to the present invention.

In the planar state, the liquid crystal layer 19 selectively reflects a bandwidth of light that is incident upon it. The wavelengths λ of the reflected light are given by Bragg's law, ie λ=nP, where wavelength λ of the reflected wavelength, n is the refractive index of the liquid crystal material seen by the light and P is the pitch length of the liquid crystal material. Thus in principle any colour can be reflected as a design choice by selection of the pitch length P. That being said, there are a number of further factors which determine the exact colour, as known to the skilled person. Not all the incident light is reflected in the planar state. In a typical full colour display device 24 employing three cells 10, as described further below, the total reflectivity is typically of the order of 30%. The light not reflected by the liquid crystal layer 19 is transmitted through the liquid crystal layer 19 and subsequently absorbed by a black layer 27 described in more detail below. In the present drive scheme, the planar state is used as the bright state.

In the focal conic state, the liquid crystal layer 19 is, relative to the planar state, transmissive and transmits incident light, although strictly speaking the liquid crystal layer 19 is mildly light scattering with a small reflectance, typically of the order of 3-4%. Thus, with the black layer 27 behind the cell 10, described in more detail below, this state is perceived as black. In the present drive scheme, the focal conic state is used as the dark state.

The focal conic and planar states are stable states which can coexist when no drive signal is applied to the liquid crystal layer 19. Furthermore, the liquid crystal layer 19 can exist in stable states in which the different domains of the liquid crystal material are each in a respective one of the focal conic state and the planar state. A range of such stable states is possible with different mixtures of the amount of liquid crystal in each of the focal conic and planar states so that the overall reflectance of the liquid crystal material varies across the stable states.

In the homeotropic state, the liquid crystal layer 19 is even more transmissive than in the focal conic state, typically having a reflectance of the order of 0.5-0.75%.

The focal conic and planar states are stable states which can coexist when no drive signal is applied to the liquid crystal layer 19. The homeotropic state is not stable and so on cessation of a drive signal which drives the liquid crystal layer 19 into the homeotropic state the liquid crystal layer 19 relaxes over a short period of time into a stable state, for example the planar state if the drive signal has a fast transition to zero voltage.

The display device 24 will now be described with reference to FIG. 3.

The display device 24 comprises a stack of cells 10R, 10G and 10B, each being a cell 10 of the type shown in FIG. 2 and described above. The cells 10R, 10G and 10B have respective liquid crystal layers 19 which are arranged to reflect light with colours of red, green and blue, respectively. Thus the cells 10R, 10G and 10B will thus be referred to as the red cell 10R, the green cell 10G and the blue cell 10B. Selective use of the red cell 10R, the green cell 10G and the blue cell 10B allows the display of images in full colour, but in general a display device could be made with any number of cells 10, including one.

In FIG. 3, the front of the display device 24 from which side the viewer is positioned is uppermost and the rear of the display device 24 is lowermost. Thus, the order of the cells 10 from front to rear is the blue cell 10B, the green cell 10G and the red cell 10R. This order is preferred for the reasons disclosed in West and Bodnar, “Optimization of Stacks of Reflective Cholesteric Films for Full Colour Displays”, Asia Display 1999 pp 20-32, although in principle any other order could be used.

The adjacent pair of cells 10R and 10G and the adjacent pair of cells 10G and 10B are each held together by respective adhesive layers 25 and 26.

The display device 24 has a black layer 27 disposed to the rear, in particular by being formed on a rear surface of the red cell 10R which is rearmost. The black layer 21 may be formed as a layer of black paint. In use, the black layer 27 absorbs any incident light which is not reflected by the cells 10R, 10G or 10B. Thus when all the cells 10R, 10G or 10B are switched into the black state, the display device appears black.

The display device 24 is similar to the type of device disclosed in WO-01/88688 which is incorporated herein by reference and the teachings of which may be applied to the present invention.

The conductive layers 13 and 14 are patterned to provide an electrode arrangement as shown in FIG. 4 which is a perspective view of a portion of the layer 19 of cholesteric liquid crystal material and the conductive layers 13 and 14 with the other components of the cell 10 omitted for clarity. In particular each conductive layer 13 and 14 is shaped as a respective array of linear electrodes 28 and 29 with the electrodes 28 and 29 of each conductive layer 13 and 14 extending perpendicular to one another. This is a conventional passive multiplexed addressing electrode arrangement. Such an electrode arrangement is capable of addressing the portions of the layer 19 of cholesteric liquid crystal material at each intersection between the electrodes 28 and 29 of the respective conductive layers 13 and 14 as a two-dimensional rectangular array of pixels.

Alternatively, the conductive layers 13 and 14 may be patterned to provide some other electrode arrangement which allows driving of portions of the layer 19 of cholesteric liquid crystal material as pixels.

A control circuit 22 supplies drive signals to the conductive layers 13 and 14 of each cell 10 to apply an electric field across the liquid crystal layer 19 to drive the liquid crystal material of each pixel selectively into a stable state having the desired reflectance. The control circuit 22 addresses respective pixels by selection of the individual electrodes 28 and 29 of each array in a conventional manner, for example in a scanning manner in which successive lines are scanned by selection of the electrodes 28 of one array and for each scanned line the appropriate drive signal is applied to each pixel by supply of the drive signal to the respective electrode 29 of the other array.

To drive the liquid crystal layer 19 into a stable state having a reflectance above that of the focal conic state, the control circuit 22 applies a drive signal of a known form, for example in accordance with the known drive schemes described above. One possibility is for the drive signal to consist of an initial pulse to drive the material into the homeotropic state, followed by a relaxation period, followed by a selection pulse of variable energy to select a stable state of variable reflectance. The selection pulse may have a voltage selected in accordance with the curve shown in FIG. 1 to provide a reflectance at any point along that curve, thereby allowing grey scale to be achieved, for example as disclosed in Huang et al., “Full Colour (4096 Colours) Reflective Cholesteric Liquid Crystal Display”, Asia Display 1998, pp 883-885 1973, which is incorporated herein by reference and the teachings of which may be applied to the present invention.

Typically, the drive signals take the form of pulses. The pulses may be of 30-50V with an AC or bipolar pulse of duration 50-100 ms to switch the liquid crystal into the homeotropic state from which there is a fast switch-off into the planar state. The drive signal may be one or more (often 2 to 5) pulses of 10-20V and 1-50 ms duration to switch the liquid crystal into the stable state. Alternatively, pulses of 30-50V with a short duration may be used. The optimisation of the drive pulses may be found experimentally for a given configuration of the cell 10 as the exact amplitude and duration depends on a number of factors such as the thickness of the liquid crystal layer 19, the dielectric anisotropy of the liquid crystal and temperature. Thus the actual drive signal may differ from the values given above although those values are suitable starting values for the optimisation process.

To drive the liquid crystal layer 19 into the focal conic state, the control circuit 22 applies a drive signal in accordance with the present invention as will now be described. To assist in distinguishing from the known drive schemes, this drive signal will be referred to as the LSS drive scheme (LSS standing for low scatter scheme)

In the following description, reference is made to the following voltages. V1 to V4 are defined for cholesteric liquid crystal material in the planar state as explained above with reference to FIG. 1, i.e V1 is the maximum voltage of the drive pulse that does not change the state of the material and V2 is the minimum voltage that switches it to a fall focal conic state, V3 is the maximum voltage that switches it to a full focal conic state and V4 is the minimum voltage that switches it to the full homeotropic state. Furthermore, for display devices having arrays of linear electrodes extending perpendicular to each other in rows and columns, Vr is the voltage applying to a row, VcActive is the voltage applied to active (driven) columns.

Essentially, the embodiments relate to a cholesteric to homeotropic nematic transition, which is a field effect and thus can be quoted as volts per micron cell thickness.

An example of the LSS drive signal applied to a cell 10 is shown in FIG. 5 which is a voltage trace from an oscilloscope of the actual drive signal. The drive signal comprises a series of pulses 30 of alternating polarity. The pulses 30 have a duration of 50 ms and no spacing therebetween. In fact the pulses 30 have a square waveform although the resolution of the oscilloscope causes them to appear slightly rounded in FIG. 5.

The initial pulse 30 has an amplitude well above the level (Vc) needed to drive the liquid crystal layer into the homeotropic state. Typically the initial pulse 30 has an amplitude of order 50V to 60V. The subsequent pulses 30 have amplitudes which reduce monotonically so that the energies of the pulses 30 also reduce monotonically. The amplitudes and energies of the pulses reduce to zero. In this example adjacent pairs of pulses 30 of opposite polarity have the same polarity and the amplitudes of each successive pulse 30 of the same polarity reduce by 5%. This series of pulses has been found to drive the liquid crystal material of the layer 19 into a focal conic state which has a low degree of scattering of light and hence has a low reflectance, as compared to a focal conic state accessed using the known drive schemes described above.

The LSS drive scheme can be contrasted with a known drive scheme in which, after an initial reset pulse driving the cholesteric liquid crystal material into a homeotropic state, the high voltage electric field is suddenly removed and over a relaxation period the cholesteric liquid crystal material relaxes into a planar state. It is noted that this is the drive scheme used by the control circuit 22 to drive the layer 19 of liquid crystal material into a stable state having a reflectance higher than that of the focal conic state. The drive signal for this known drive scheme is shown in FIG. 6 comprising an initial reset pulse 31 (which may in general be a pulse of one polarity, a DC balance pulse or an AC pulse), followed by a relaxation period 32, followed by a selection pulse 33. There are a number n of selection pulses 33 which may be plural. To achieve grey levels by driving the layer 19 of liquid crystal material into a stable state having a reflectance higher than that of the focal conic state, the control circuit 22 provides the selection pulse 33 with a voltage between V1 and V2 or between V3 and V4. In accordance with the known drive scheme, to drive the layer 19 of liquid crystal material into the focal conic state the selection pulse has voltage between V2 and V3.

Although the control circuit 22 applies the LSS drive signal instead of the known drive signal to achieve the focal conic state, tests have been performed by applying both the known drive signal and the LSS drive signal to actual cells 10 and measuring the contrast ratio obtained.

Firstly, tests were performed on two cells 10 contained a layer of liquid crystal material being respectively SE130B and SE7511L which are green cholesteric liquid crystal polyimides from Nissan Chemicals. In each case the thickness of the layer 19 was 6 μm. The results of these tests for the known drive scheme are shown in Table 1 and the results for the LSS drive signal are shown in Table 2.

TABLE 1

| | | | width | | Contrast ratio | |
|---|---|---|---|---|---|---|
| | | width | of | width | (Planar/focal conic reflectance) | |
| | | of pulse | period | of pulse | SE130B | SE7511L |
| Conventional | | 31 | 32 | 33 | Homogeneous | Homeotropic |
| scheme | n | (ms) | (ms) | (ms) | alignment | alignment |
| | 1 | 50 | 450 | 10 | 5 | 9 |
| | 2 | 50 | 450 | 10 | 5 | 11 |
| | 3 | 50 | 450 | 10 | 5 | 12 |
| | 6 | 50 | 450 | 10 | 6 | 13 |
| | 1 | 50 | 0 | 10 | 4 | 12 |
| | 2 | 50 | 0 | 10 | 4 | 13 |
| | 3 | 50 | 0 | 10 | 5 | 13 |
| | 6 | 50 | 0 | 10 | 5 | 13 |

TABLE 2

| | | | | Contrast ratio | |
|---|---|---|---|---|---|
| | | | | (Planar/focal conic reflectance) | |
| | Pulse | | Reduction in | SE130B | SE7511L |
| Low scatter | width | No of | voltage at each | Homogeneous | Holmeotropic |
| scheme | (ms) | pulses | pulse | alignment | alignment |
| LSS | 50 | 21 | 10% | 11 | 17 |

For each liquid crystal material, the planar state had the same reflectance, but the focal conic state had a different reflectance such that even the best conventional scheme has a much lower contrast ratio than that from the LSS drive scheme.

Secondly, tests were performed on a cell 10 comprising a layer 19 of thickness 6 μm of liquid crystal material which was Merck BL087 host liquid crystal containing Merck S811 chiral dopant.

In this case, the known drive signal was applied with a balanced DC reset pulse 31 of amplitude 60V, a relaxation period 32 of 50 ms, and two balanced DC selection pulses 33 of duration 14 ms and spacing 50 ms. This produced a minimum reflectance focal conic state when the amplitude of the selection pulses was 27V. In this state the reflectance was 2.65% of the standard white giving a contrast ratio of 6.99.

The LSS drive signal of the form shown in FIG. 5 was applied with the voltage of the initial pulse being 60V, the reduction in voltage being 1V for each successive pulse 30 of the same polarity, and the duration of each positive or negative polarity pulse 30 being 5 ms (i.e. the duration of a balanced DC pulse consisting of two pulses 30 being 10 ms). This produced a focal conic state having a reflectance of 1.05% of standard white giving a contrast ratio of 17.61.

Again, these tests show that the LSS drive signal allow the production of a focal conic state having an improved reflectance and contrast ratio.

In addition, it is important to note that the series of pulse shown in FIG. 5 can be implemented without detailed knowledge of the voltages V1 to V4 of the liquid crystal material. The initial pulse 30 must have a voltage above V4 but it is easy to pick a relatively high voltage such that the actual value of V4 for the cell 10 in question need not be determined. The reduction of the voltages of the pulses 30 means equally that the voltages V2 and V3 need not be known. This is in stark contrast to the known drive scheme where the voltages V2 and V3 need to be known to drive the liquid crystal material into the focal conic state, which increases difficulty and cost of manufacture either because strict tolerances need to be applied to the manufacture of the cell 10 or because testing of each manufactured cell 10 is needed. Thus the use of the series of pulses 30 of the LSS drive signal reduces these manufacturing problems allowing reduced cost and higher yield.

Many variations of the form of the LSS drive signal shown in FIG. 5 may be applied provided that after one or more initial pulses there are subsequent pulses which have a time-averaged energy which reduces. Some examples of such modifications are as follows.

A number of variations may be applied to reduce the overall duration of the series of pulses 30. Three possibilities for reducing the overall duration are:

(1) increasing the voltage drop for each successive pulse 30;

(2) reducing the duration of each pulse 30; and/or

(3) increasing the minimum level to which the energy of the pulses 30 in the series falls, i.e. instead of falling to zero it could fall to a minimum level above zero.

These three possibilities have been studied as follows.

### (1) Increasing the Voltage Drop for Each Successive Pulse 30.

The voltage drop for successive pulses 30 can be varied. 1% to 10% drops in voltage per pulse 30 were tested. It was found that with more pulses 30, i.e. with less voltage drop per pulse 30, the contrast ratio was a little higher especially when used with homeotropic alignments. Table 3 shows the results when pulses 30 of duration 50 ms and 10 ms pulse were used in cells 10 of the same type as used in the tests described above, in particular with homogeneous alignment of the liquid crystal material.

TABLE 3

| | | | | Contrast ratio | |
|---|---|---|---|---|---|
| | | | | (Planar/focal conic reflectance) | |
| | Pulse | No. of | Reduction in | SE130B | SE7511L |
| Low scatter | width | pulses | voltage at each | Homogeneous | Holmeotropic |
| scheme | (ms) | 30 | pulse 30 | alignment | alignment |
| LSS 10% | 50 | 21 | 10% | 11 | 17 |
| LSS FC 2 5% | 50 | 42 | 5% | 11 | 19 |
| LSS 10% | 10 | 21 | 10% | 10 | 21 |
| LSS FC 2 5% | 10 | 42 | 5% | 11 | 25 |

Similarly, FIG. 7 shows data on different liquid crystal material having different wavelengths of reflection in the planar state, FIG. 7 being a graph of the degree of back scattered light (shown by Y in arbitrary units) against the voltage drop for successive pulses 30. For each material there is a reduction in the back scattered light as the voltage drop reduces.

### (2) Reducing the Duration of Each Pulse 30.

In general the duration of the pulses 30 is 100 ms or less. The duration of the pulses 30 of the LSS drive signal shown in FIG. 5 was reduced from 50 ms to values of 10 ms, 5 ms and 2.5 ms using a cell 10 with a homogeneous alignment layer (PI 3) 19 and green cholesteric liquid crystal material. The contrast ratios achieved are shown in Table 4.

TABLE 4

| Pulse length | Contrast Ratio |
|---|---|
| 50 ms | 15.7 |
| 10 ms | 15.4 |
| 5 ms | 12.1 |
| 2.5 ms | 5.7 |

It can be seen from Table 4 that longer pulses 30 provide the best contrast ratio but that it is possible to apply some reduction in the duration of pulses 30 and hence reduction in the overall duration of the series of pulses 30 with a relatively small cost in the contrast ratio. On balance it is preferred that the pulses are of duration at most 20 ms.

As can also be seen from Table 4, there is a critical value at which the contrast ratio is significantly degraded, being somewhere between 5 ms and 2.5 ms for this particular cell but in general this is probably both material and temperature dependent. Although the LSS drive scheme still works with small durations, for this reason it is preferred that the pulses 30 have a duration of at least 5 ms. In general, the duration of the pulses 30 can be optimized for the conditions and materials used by testing of different durations.

### (3) Increasing the Minimum Level of the Energy of the Pulses 30 in the Series

In general, the minimum level to which the energy of the pulses 30 falls can be above zero, provided that it is sufficiently low that the liquid crystal material is driven into the focal conic state. This minimum level can be determined experimentally although it places some restriction on the nature of the cell 10 whereas reduction to a minimum level of zero is applicable to any cell. Thus in practice, the minimum level is selected as a balance between reduction of the overall duration of the series of pulses 30 and increasing the manufacturing constraints. In general terms, increasing the minimum level can achieve a reduction in the overall duration of the series of pulses 30 of the order of 50%, as compared to a minimum level of zero.

To demonstate this, a series of tests were performed by applying the drive signal shown in FIG. 5 to a cell 10 but with dropping increasing numbers of the pulses 30 at the end of the series so that the minimum level increased correspondingly. The results are shown in FIG. 8 which is a graph of the reflectance (arbitrary units) of the cell 10 after application of the drive signal against the number of pulses 30 dropped. Curves for two different liquid crystal materials are shown, the triangles indicating points for red cholesteric liquid crystal material and the squares indicating points for green cholesteric material. For each material, there is a number of dropped pulses, and hence a minimum energy at which the low reflectance focal conic state ceases to be achieved. The number of dropped pulses, and hence the minimum energy, is lower for the red cholesteric liquid crystal material than for the green cholesteric liquid crystal material.

Furthermore, the minimum level corresponds to approximately V2 if the curve shown in FIG. 1 is obtained using a scheme consistent with this concept having a no pause between the initial pulse 30 and the subsequent pulses 30, this having been determined experimentally as shown in Table 5.

TABLE 5

| | Known drive scheme | LSS type concept with |
|---|---|---|
| | 500 ms relaxation period 32 between | no pause between reset and |
| | initial pulse 31 and selection pulse 33 | select pulses 30 |
| V1 | 19 V | 17 V |
| V2 | 32 V | 25 V |
| V3 | 35 V | 27.5 V |
| V4 | 43 V | 43 V |

Other variations to the drive signal may alter the waveform of the series of pulses 30. Examples of such variations will now be described with reference to FIGS. 9 to 14 which are each graphs of voltage over time for respective drive signals. In FIGS. 9 to 14, a relatively small number of pulses are shown for clarity although actual drive schemes may employ larger numbers of pulses.

In the LSS drive signal shown in FIG. 5, the energy is reduced by using pulses 30 of constant duration and reducing amplitude. This drive signal is shown again in an enlarged manner in FIG. 9.

As an alternative the pulses 30 could be spaced apart, preferably by a constant spacing, for example using a drive signal as shown in FIG. 10 in which each pulse 30 is separated by a spacing of duration tg. To study this, tests were performed on a cell 10 comprising a layer 19 of thickness 6 μm of liquid crystal material which was Merck BL087 host liquid crystal containing Merck S811 chiral dopant, as mentioned above. The LSS drive signal of the form shown in FIG. 10 was applied with the voltage of the initial pulse 30 being 60V, the reduction in voltage for each successive pulse 30 being 1V, and the duration of each pulse 30 being 5 ms. The LSS drive signal had a constant spacing tg between the balanced DC pulses 30, the tests being repeated for different values of this spacing tg. Table 6 shows the results.

TABLE 6

| | | Contrast ratio of |
|---|---|---|
| Spacing tg | Reflectance as a | focal conic state |
| between pulses | percentage of | with respect to |
| 35 (ms) | standard white | planar state |
| 0 | 1.05 | 17.61 |
| 0.05 | 1.02 | 18.13 |
| 0.5 | 0.98 | 18.82 |
| 1 | 0.98 | 18.96 |
| 2 | 1.01 | 18.41 |
| 5 | 1.07 | 17.33 |
| 10 | 1.09 | 16.98 |
| 30 | 1.11 | 16.66 |

Two points may be seen from these results. Firstly, no matter what the spacing tg, the LSS drive signal shown in FIG. 10 produces significantly better reflectance and contrast ratio than the known drive signal applied to the same cell as reported above. Secondly, the optimum spacing tg is around 0.5 ms to 1 ms. This is the period of time it takes for the liquid crystal material to relax into the transient planar state, this being a well known state of cholesteric liquid crystal material which is similar to the stable planar state but with a longer pitch length, in fact about twice the pitch length. Thus, in general it is believed that best results can be achieved with a drive signal comprising a series of pulses having a spacing sufficient to allow the cholesteric liquid material to relax into the transient planar state.

However, the energy of the pulses 30 may be reduced in a different manner, for example as follows.

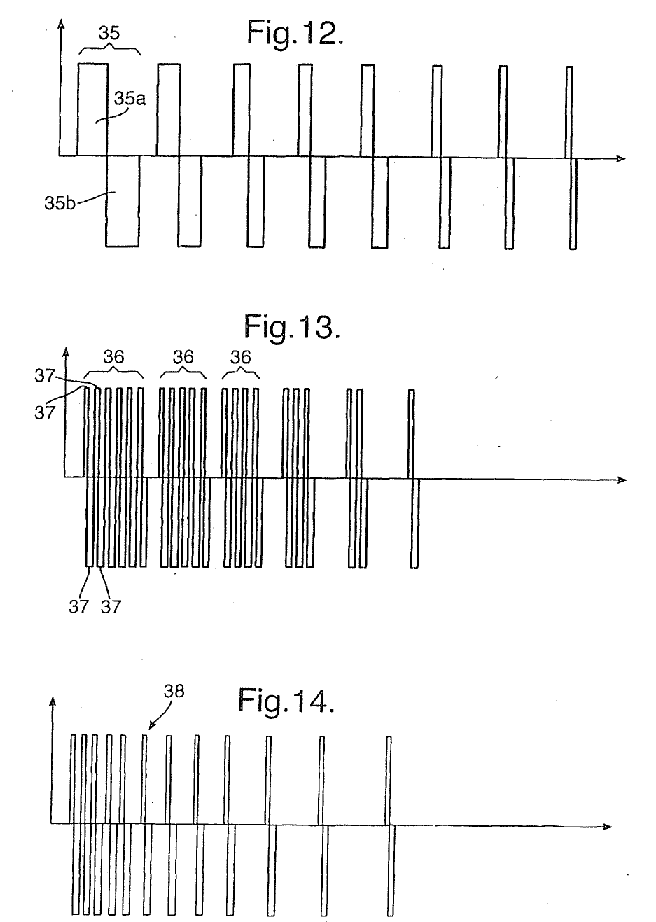

FIG. 11 shows a drive signal in which the energy of the pulses 34 is reduced by pulse width modulation. In this case, the pulses 34 are the same as shown in FIG. 9 but with a constant amplitude and a reducing duration. Use of pulses 34 of constant amplitude has the advantage of simplifying the circuitry used to generate the signal, this a major advantage of pulse width modulation in general.

FIG. 12 shows a drive signal employing pulse width modulation as in FIG. 11 but with spacings between the pulses 35. In this case each pulse 35 is a balanced DC pulse and so might equally be considered as two unipolar pulses 35a and 35b of opposite polarity without any spacing therebetween. The spacing between the pulses 35 may increase so that the frequency of the pulses 35 is constant or the spacing between the pulses 35 may be constant. In either case, the time-averaged energy of the pulses 35 reduces.

FIG. 13 shows a drive signal employing pulse width modulated AC pulses 36. In particular each pulse 36 is an AC pulse with a constant amplitude and a reducing duration to reduce the energy of the pulses 36. The spacing between the pulses 36 may increase so that the frequency of the pulses 36 is constant or the spacing between the pulses 36 may be constant. In either case, the time-averaged energy of the pulses 36 reduces. It is to be noted that an individual AC pulse 36 in FIG. 13 could equally be thought of as a group of pulses 37 of alternating polarity with no spacing therebetween. In this case, it is appropriate to consider the drive signal as comprising groups of pulses 37 with a reducing number of pulses 37 in each group.

FIG. 14 shows a drive signal comprising pulses 38 having the same amplitude and duration but with increasing spacings between the pulses 38. In this case although the energy of each pulse 38 is the same, the increasing spacing means that the time-averaged energy of the pulses 38 reduces along the series of pulses 38.

Thus FIGS. 9 to 14 show drive signals in which the time-averaged energy of the pulses 30 and 34 to 38 is reduced in different manners. Of course it is possible to reduce the time-averaged energy of pulses in other manners as well, for example by combining the techniques applied in the drive signals of FIGS. 9 to 14. And of course all combination of the above.

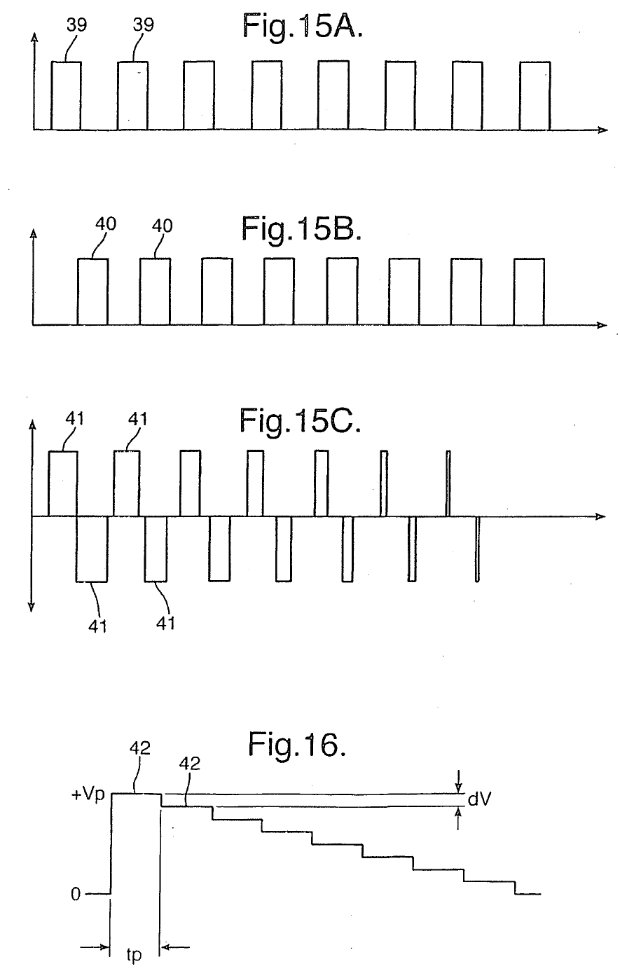

The drive signals described above may be applied by directly applying the a waveform having the form shown in FIGS. 9 to 14 to one of the conductive layers 13 or 14 of the cell 10. As an alternative, unipolar pulses may be applied to each one of the conductive layers 13 and 14 so that the drive signal experienced by the layer 19 of cholesteric liquid crystal material is of the form shown in FIGS. 9 to 14. An example of this is shown in FIGS. 15A to 15C, FIGS. 15A and 15B showing the unipolar pulses 39 and 40 applied to the respective conductive layers 13 and 14 to produce a drive signal across the layer 19 as shown in FIG. 15C having pulses 41 in the same form as the drive signal of FIG. 12.

The shape of the pulses 30 and 34 to 38 is not critical. Whilst pulses 30 having a square waveform are preferred for ease of generation, other waveforms are equally possible.

All the drive signals described above are DC balanced within each series of pulses 30, 34 to 38 and 41 to prevent electrolysis. Thus the pulses are either of alternating polarity or are AC pulses. However this is not essential. As an alternative the pulses could be unipolar (for example by removing the pulses of negative polarity in the drive signals of FIGS. 9 to 14). In this case, it would still be desirable to provide DC balancing between successive series of pulses, for example by alternating the polarity of each successive series of pulses.

FIG. 16 shows an example of a LSS drive signal comprising a series of unipolar pulses 42. As the pulses 42 have no spacing therebetween, the series of pulses can equally be considered as a single pulse having an amplitude which decreases in a series of steps. Possible modifications to the drive signal shown in FIG. 16 are for the voltage of the drive signal to decrease linearly (which is equivalent to a series of infinitely small pulses) or for there to be spacings between the pulses 42.

To study the use of unipolar pulses, tests were performed on a cell 10 comprising a layer 19 of thickness 6 μm of liquid crystal material which was Merck BL087 host liquid crystal containing Merck S811 chiral dopant, as mentioned above. The LSS drive signal of the form shown in FIG. 16 was applied with the voltage of the initial pulse 42 being 60V, the reduction in voltage for each successive pulse 42 being 1V, and the duration of each pulse 42 being 10 ms. This produced a focal conic state having a reflectance of 1.34% of standard white giving a contrast ratio of 13.79. This shows that use of unipolar pulses 42 provides a clear improvement over the known drive signal applied to the same cell 10 as reported above.

However, the reflectance of the focal conic state and the contrast ratio was degraded as compared to the drive signal of FIG. 5 applied to the same cell 10 as reported above. In the drive signal of FIG. 5, two successive pulses 30 of positive and negative polarity may be considered together as a balanced DC pulse which is equivalent to a single unipolar pulse 42 of FIG. 16. Accordingly tests were performed using the drive signal of FIG. 16 but with longer unipolar pulses 42. Unipolar pulses 42 of duration 15 ms produced a focal conic state having a reflectance of 1.19% of standard white giving a contrast ratio of 15.60. Unipolar pulses 42 of duration 20 ms produced a focal conic state having a reflectance of 1.10% of standard white giving a contrast ratio of 16.86. This shows that unipolar pulses 42 of longer duration can produce a contrast ratio equivalent to that of pulses of alternating polarity. This is at the expense of the overall duration of the series of pulses being longer.

There will now be described the implementation of this drive scheme to an actual cholesteric display device 24. The display device 24 was made as described above with red, green and blue cells 10R, 10B and 10G each having a layer 19 of liquid crystal material of thickness 5 μm to 6 μm The following results where found compared to the same display device 24 driven in the known drive scheme. The display device 24 was held at 25° C. to 30° C. The Yxy values were measured using a Minolta CS100 colour camera, Yxy referring to the 1931 CIE chromaticity diagram of colour and brightness representation. Tables 7 and 8 shows two examples of using the LSS scheme compared to a conventional drive scheme.

TABLE 7

| | | | | CR |
|---|---|---|---|---|
| Colour | Y | x | y | White/black |
| Red | 10.76 | 0.4128 | 0.3445 | |
| Green | 15.65 | 0.2593 | 0.3883 | |
| Blue | 9.028 | 0.1902 | 0.1909 | |
| White | 23.56 | .2686 | .2998 | |
| Black (slow scan) | 3.95 | 0.2847 | 0.2741 | 5.96 |
| Black (LSS) | 3.08 | 0.3021 | 0.272 | 7.65 |

TABLE 8

| | | | | CR |
|---|---|---|---|---|
| Colour | Y | x | y | White/black |
| Red | 10.15 | 0.4067 | 0.3404 | |
| Green | 14.64 | 0.2568 | 0.3829 | |
| Blue | 8.55 | 0.1911 | 0.1895 | |
| White | 29.89 | 0.2732 | 0.3186 | |
| Black (slow scan) | 3.78 | 0.2816 | 0.2695 | 7.91 |
| Black (LSS) | 2.911 | 0.2919 | 0.2454 | 10.26 |

It can be seen from Tables 7 and 6 that use of the LSS drive signal gives around a 22% increase in contrast ratio.

The known drive scheme applied to a passive multiplexed addressing electrode arrangement has the following problems. In a matrix of M columns×N rows the voltage (Vp) on the pixel (m,n) is Vm (Voltage on column m)−Vn (Voltage on row n) Simple scanning matrix driving is based on sequential line (column) by line (column) driving. When driving multistable stable materials like cholesteric LC the appropriate optical state (reflectance) of the pixels in a specific column that is achieved during (or immediately after) driving this column and should not change due to rest of the scanning (driving of the other columns) i.e. subsequent driving of later pixels should not affect those that have been driven.

Since the left side of the curve shown in FIG. 1, hereinafter referred to as the EOC (electro-optic curve) is less steep then the right side ((V2−V1)>V4−V3)) it is easier to achieved more grey levels by driving on the left-side which is also less sensitive to variation in cell thickness and other physical parameters.

Driving on the left side of the EOC usually consists of 2 steps, namely:

(1) Resetting to planar state—all the matrix or each driven column is driven to planar state (giving white in a three layer RGB stack).
(2) The columns are scanned sequentially by applying an appropriate voltage to each column and row so that the voltage on the driven pixels (Vr−VcActive) is in the range V1-V2.

If VcActive=0, Vrmax (maximum voltage applied to the rows)=V2 and Vrmin (minimum voltage applying to rows)=V1.

To ensure that the non selected or non driven pixels are not changed it is essential to set the voltage on all such pixels (Vc non active) so that: VcNonActive−VrowMin<=V1 and VrMax−VcNonActive<=V1, where VrMax and VrMin are the maximum and minimum voltage applying to the rows of the matrix.

Practically, VcNonactive is set to (Vrmax+Vrmin)/2, usually with the requirement that (V2−V1)<2V1.

A basic limitation of working on the left side of the EOC is that the steepness near V2 is relatively small. Thus to achieve a low reflectance Vrmax is usually increased. But sometimes this is the opposite and the voltage on the pixels in the non-driven columns in higher then V1 and their reflectance decreases.

This drawback becomes more severe as more columns are scanned; thus limiting the size of the matrix.

Another method to drive the cholesteric material to a low reflectance state (focal conic) without increasing Vrmax is to increase the pulse time or to apply more than one pulse to each column. Since the pulse time and the number of pulses is applied to all other non-driven pixels (the pixels in the non-active columns), this method may also reduce their reflectance.

As shown in the example, to reduce the reflectance of specific area (6×6 pixels) on a 32×32 checkerboard picture to the same level achieved in the LSS method—The reflectance of the white areas (and the contrast of the picture) are reduced by more then 30%.

Another drawback of increasing pulse time/number of pulses is that the EOC is steeper and this reduces the number of grey levels that can be achieved.

However there are advantages of using the LSS drive signal with a passive multiplexed addressing electrode arrangement, as follows.

The way of implementing the LSS drive signal in matrix driving is based on 3 steps, as follows:

(1) All pixels in the matrix are driven to FC (focal conic) by the LSS method. This can be done by:
(a) Applying the same voltage to all columns and the same voltage to all segments (treating the matrix as a large cell); or
(b) Scanning column by column: apply the same voltage to all rows and all non-active columns and the appropriate voltage to the active columns (treating one column as single pixel one at a time).
(2) Then a mask picture is created. The mask picture consists of all the pixels in the picture that should be driven to the lowest reflectance level (the most dark pixels). All other pixels are driven to planer state (bright state), on the right side of the EOC. Vrmax is set such that Vrmax>=V4 (to drive the pixels that are set to planar) and Vrmin<=V3 (applied to the darker the darker pixels). VcNonActive is set to (V4−V3)/2 and since the right side of the EOC is much steeper (V4−V3)<(V2−V1), the non-active voltage is relatively small. The reduction in reflectance of the pixels on the non-active columns is small compared to driving on the left side of the EOC.
(3) The picture is driven normally (left side of the EOC) but Vrmax is reduced to less then V2.

Since the voltage on all driven cells is much less then V3, the pixels that were set to the focal conic state will not change state and the darker area in the picture will stay dark. Since Vmax (and so Vmax−Vmin) is small the voltage on the non-active pixels is also small. Thus the reflectance reduction is smaller. Also less scanning pulses and or shorter pulses are needed.

As another example there was made a display device 24 having a stack of red, green and blue cells 10R, 10G and 10B each having 32 rows and 32 columns of pixels. Columns were connected in parallel between cells 10R, 10G and 10B so that the total matrix size is 32 columns×96 rows. The pixel size is 5 mm by 5 mm.

A comparison was between the known drive scheme and the LSS drive signal. The picture tested was a 32×32-checkerboard. The picture included one 6×6 pixel white square and one 6×6 pixel black square. Reflectance measurement was carried out on the black and white squares using a Minolta CS100 color camera.

Normal (Left side EOC) Driving Voltage was applied. The first step was to reset all the matrix to planar by applying 20 ms 46 volt pulse (32 columns connected to the same voltage Vc and all 96 rows to Vr, VC−Vr=46 volt). The second step was to scan 32 columns with the following parameters:

Different pulse times were used as follows:

First step:
Vactive=0 volt

### Vrmax=28 Volt

### Vrmin=11 Volt

### VcNonActive=19 Volt

The results with the known drive scheme are shown in Tables 9 and 10, Table 9 showing the results for a scanning pulse time of 8 ms and Table 10 showing the results for a scanning pulse time of 14 ms.

TABLE 9
Initial reflectance (after Planer Reset)
Reflectance 2.4

| | Number of pulses | | | | | | |
|---|---|---|---|---|---|---|---|
| | 1 | 2 | 3 | 4 | 5 | 6 | 10 |
| | Reflectance | | | | | | |
| Black | 0.61 | 0.6 | 0.5 | 0.48 | 0.46 | 0.45 | 0.44 |
| White after | 2.28 | 2.25 | 2.22 | 2.19 | 2.16 | 2.13 | 2.04 |
| scanning | | | | | | | |
| Final CR | 3.74 | 3.75 | 4.44 | 4.56 | 4.7 | 4.7 | 4.64 |

TABLE 10
Initial reflectance (after Planer Reset)
Reflectance 2.39

| | Number of pulses | | | | | | |
|---|---|---|---|---|---|---|---|
| | 1 | 2 | 3 | 4 | 5 | 6 | 10 |
| | Reflectance | | | | | | |
| Black | 0.53 | 0.46 | 0.44 | 0.42 | 0.41 | 0.4 | 0.39 |
| White after | 2.2 | 2.12 | 2.04 | 2.16 | 1.98 | 1.9 | 1.65 |
| scanning | | | | | | | |
| Final CR | 4.15 | 4.61 | 4.64 | 5.14 | 4.83 | 4.75 | 4.23 |

Thus it can be seen that longer pulses give lower reflectance of the focal conic state and planar state but overall a higher contrast ratio. Here it is seen that as the number of pulses is increased the dark state becomes less reflective and the contrast ratio increases but after a maximum it decreases because the bright state becomes increasingly affected (reduced) by successive pulses. In a large array of pixels this has seriously adverse effect on the contrast ratio.

Next the LSS drive signal was applied with the following parameters:

LSS Mask voltage (driving right side of EOC):
Vactive=0 volt
Vrmax=46 Volt (same as reset)

### Vrmin=27 Volt

### VcNonActive=37 Volt

The LSS drive signal was applied in the form shown in FIG. 5 with 40 pulses of 5 ms duration and amplitude linearly decreasing from 40V to 0V.

The normal driving parameters were as follows:

Same voltage as example 1, but only 2 pulses (8 ms each)
Vactive=0 volt

### Vrmax=28 Volt

### Vrmin=11 Volt

### VcNonActive=19 Volt

Table 11 shows the results.

TABLE 11

| | | Reflectance |
|---|---|---|
| | State | value |
| LSS scheme | | 0.38 |
| After Mask stage | white | 2.35 |
| | black | 0.39 |
| After Driving | White | 2.33 |
| | black | 0.39 |
| Final CR | | 5.97 |

| | |
|---|---|
| Planer at Rest (for reference only | 2.39 |
| gives the best white state) | |

Thus it is now seen that both the black state and white states are very good having values that in both cases improve (i.e. high white and low black values) on those of the normal driving scheme. Thus the contrast ratio is very high.

Numbers, alphabetic characters, and roman symbols are designated in the above description for convenience of explanation only, and should by no means be regarded as imposing particular order on any method steps. Likewise, while the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

In describing the present invention, explanations have been presented in light of currently accepted scientific theories and models. Such theories and models are in general subject to change, both adiabatic and radical. Often these changes occur because representations for fundamental elements are developed, because new transformations between these elements are conceived, or because new interpretations arise for these elements or for their transformations. Therefore, it is important to note that the present invention relates to specific technological actualization in embodiments. Accordingly, any theory or model presented herein, related to these embodiments, are presented for the purpose of teaching how these embodiments may be substantially realized in practice. Alternative or equivalent explanations for these embodiments may neither deny nor alter their realization.

### LIST OF REFERENCES

W Greubel et al., Mol Cryst Liq Cryst., vol 24, page 103, 1973
P R Gerber, Z Naturforschung, page 718, 1981 and G W Gray, Chimia, 34, page 47 1980.
E Leuder, Liquid Crystal Displays, Published by Wiley/SID series in Display Technology, page 205 to 210, 2001.
J W Doane et al, Japan Display, 1992
X Y Huang et al, SID Digest, 1995
Y M Zhu and X Y Huang, SID Digest 1997.
X Y Huang, M Stefanov et al. SID Digest, p 359, 1996.
I. Sage, “Liquid Crystals Applications and Uses”, Editor B Bahadur, vol 3, page 301, 1992, World Scientific
West and Bodnar, “Optimization of Stacks of Reflective Cholesteric Films for Full Color Displays”, Asia Display 1999 pp 20-32
Huang et al., “Full Color (4096 Colors) Reflective Cholesteric Liquid Crystal Display”, Asia Display 1998, pp 883-885, 1973

1. A method of driving a layer of cholesteric liquid crystal material into the focal conic state, the method comprising applying a drive signal to the layer of cholesteric liquid crystal material, the drive signal comprising a series of pulses wherein at least one initial pulse has sufficient energy to drive the layer of cholesteric liquid crystal material into the homeotropic state and the subsequent pulses have time-averaged energies which reduce to a minimum level at which the layer of cholesteric liquid crystal material is driven into the focal conic state.

2. A method according to claim 1, wherein the subsequent pulses have time-averaged energies which reduce monotonically.

3. A method according to claim 1, wherein the pulses are spaced.

4. A method according to claim 3, wherein the pulses are spaced by a spacing which allows the layer of cholesteric liquid crystal material to relax into the transient focal conic state.

5. A method according to claim 1, wherein the pulses have no spacing therebetween.

6. A method according to claim 1, wherein the subsequent pulses have the same width and spacing and have amplitudes which reduce.

7. A method according to claim 1, wherein the subsequent pulses have the same amplitude and have widths which reduce.

8. A method according to claim 3, wherein the subsequent pulses have the same amplitude and width and have spacings which increase.

9. A method according to claim 1, wherein the at least one initial pulse has a duration of at most 100 ms.

10. A method according to claim 1, wherein said minimum level is zero.

11. A method according to claim 1, wherein said minimum level is above zero.

12. A method according to claim 1, wherein the subsequent pulses each have a duration of at most 100 ms.

13. A method according to claim 1, wherein the subsequent pulses each have a duration of at most 20 ms.

14. A method according to claim 1, wherein the subsequent pulses each have a duration of at least 5 ms.

15. A method according to claim 1, wherein the at least one initial pulse and the subsequent pulses have the same duration.

16. A method according to claim 1, wherein within a series of pulses, the pulses are DC balanced.

17. A method according to claim 16, wherein successive pulses in the series of pulses are of alternating polarity.

18. A method according to claim 1, wherein all the pulses within a series of pulses are of the same polarity,

19. A method according to claim 1, wherein the layer of cholesteric liquid crystal material is surface-stabilised by an alignment layer arranged adjacent thereto.

20. A method according to claim 1, wherein the layer of cholesteric liquid crystal material is provided in a cell of a cholesteric liquid crystal display device having an electrode arrangement capable of applying the drive signal to the layer of cholesteric liquid crystal material.

21. A method according to claim 20, wherein the electrode arrangement is capable of addressing a plurality of pixels across the layer of cholesteric liquid crystal material by respective drive signals.

22. A method according to claim 21, wherein the electrode arrangement comprises an array of linear electrodes on each side of the layer of liquid crystal material, the linear electrodes of each array extending perpendicular to each other.

23. A method according to claim 20, wherein the cholesteric liquid crystal display device further comprises a black background layer on the rear side of the layer of liquid crystal material.

24. A cholesteric liquid crystal display device comprising:
at least one cell comprising a layer of cholesteric liquid crystal material and an electrode arrangement an electrode arrangement capable of applying a drive signal to the layer of cholesteric liquid crystal material; and
a drive circuit arranged to supply a drive signal to the electrode arrangement for application to the layer of cholesteric liquid crystal material to drive the liquid crystal material into the focal conic state, the drive signal comprising a series of pulses wherein at least one initial pulse has sufficient energy to drive the layer of cholesteric liquid crystal material into the homeotropic state and the subsequent pulses have time-averaged energies which reduce to a minimum level at which the layer of cholesteric liquid crystal material is driven into the focal conic state.
